(19) United States
(12) Patent Application Publication
(10) Pub. No.: US 2004/0252723 A1
(43) Pub. Date: Dec. 16, 2004

(54) Data transfer control method

(75) Inventors: Hiroki Tatsumoto, Osaka (JP); Toshihiro Tatsumi, Kyoto (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/862,607

(22) Filed: Jun. 8, 2004

(30) Foreign Application Priority Data
Jun. 16, 2003 (JP) 2003-170891

(51) Int. Cl. H04J 3/18

(52) U.S. Cl. 370/477; 370/468

(57) ABSTRACT

A service management section for managing quality information of a provided service and a received service is provided at each node so as to manage correspondence between each service and isochronous connections. When detecting a deficiency of the band at the start of a new service, each node determines a list of services whose quality can be decreased based on service information acquired from the service management sections of all the nodes on a transfer path and then decreases the quality of the service and reduces a corresponding isochronous connection band. Thereafter, band reservation is attempted again.

### BACKGROUND OF THE INVENTION

1. Field of the Invention

The present invention relates to a data transfer control method employed in an information control device which has the function of establishing a mutual communication based on a communication standard that provides band reservation means and which performs transmission/reception of real-time data using this function.

2. Description of the Prior Art

There has been an increasing demand for a communication system wherein various devices are provided around an AV device at the center, such as a DTV (digital television), STB (set top box), DVHS (digital VHS), DVCR (digital video cassette recorder), or the like, and these devices are connected to each other such that real-time data can be mutually transferred. For the purpose of satisfying such a demand, IEEE 1394 communication standard has been developed, and a high-speed serial bus interface based on IEEE 1394 communication standard has been developed.

In IEEE 1394 communication standard, only one IRM (isochronous resource manager) for managing the remainder of the band available for data transfer over the entire transfer path exists on the transfer path. Each communication node needs to acquire a band necessary for transfer of transmission data from the IRM before the start of transmission of real-time data, thereby reserving an IEEE 1394 serial bus band. With this mechanism, the realtimeness of transferred data is ensured.

However, in a conventional communication system based on IEEE 1394 communication standard, for example, in the case where almost all the part of the available band on the transfer path has been reserved by a plurality of communication devices, a sufficient band cannot be reserved for data transmission to be newly started. As a result, the new data transmission cannot be started before the other devices end their data transmission to release the band.

In order to avoid such a situation, Japanese Unexamined Patent Publication No. 2001-186153 discloses a method for forcibly releasing the band occupied by other communication devices to reserve a necessary band.

However, in the method of Japanese Unexamined Patent Publication No. 2001-186153, the band of communication devices are forcibly released irrespective of user's intent. Thus, there is a possibility that a communication which is not intended by a user is interrupted.

According to the specifications for connection management which are defined based on AV protocol communication standard that is a communication protocol used for AV data transfer under IEEE 1394 communication standard, IEEE 1394 serial bus band which has been reserved at the time of establishment of a broadcast connection can be released by another communication device. However, the band of a point-to-point connection cannot be released by another communication device.

### SUMMARY OF THE INVENTION

An objective of the present invention is to provide a data transfer control method wherein, when an available band in a transfer path is deficient, the quality level of a service provided by a certain communication device is decreased, and the band reserved for transfer of the service data is reduced, whereby a band necessary for communication is reserved.

Another objective of the present invention is to provide a data transfer control method wherein, when there is a service in a state of decreased quality level and there is a sufficient available band in a transfer path, the band reserved for transfer of the service data is increased such that the quality level of the service can be restored.

A data transfer control method of the present invention is employed in an information control device including a communication interface which provides band reservation means, the method comprising: a band reservation request step of requesting reservation of a communication band; if the band reservation is failed due to band deficiency, a band reduction step of reducing the band reserved by the information control device connected to a transfer path; and a released-band reservation step of reserving the band released at the band reduction step.

A data transfer control method of the present invention comprises a band increase step of increasing the band reserved by the information control device based on a band released by the information control device connected to a transfer path.

The data transfer control method of the present invention further comprises: a band reservation failure detection step of detecting a failure of band reservation due to band deficiency; and a quality level decrease step of decreasing the quality level of at least one of services related to the information control device connected to the transfer path based on the deficient band and a certain selection condition.

The data transfer control method of the present invention further comprises: a band release detection step of detecting release of a band by any information control device connected to the transfer path; and a quality level increase step of increasing the quality level of at least one of services related to the information control device based on the released band and a certain selection condition.

The quality level decrease step of the present invention includes the steps of: if the band reservation is failed, requesting all of the information control devices connected to the transfer path to acquire information of a related service; selecting a service whose quality is to be decreased based on the deficient band, the certain selection condition and the acquired service information; and requesting a decrease of the quality level of the service.

The quality level decrease step of the present invention includes the steps of: if the band reservation is failed, requesting all of the information control devices connected to the transfer path to decrease the quality level of a related service; and decreasing the quality level of the service based on the deficient band, the certain selection condition and information of the service related to the information control device.

The quality level increase step of the present invention includes the steps of: if release of the band is detected, requesting all of the information control devices connected to the transfer path to acquire information of a related service; selecting a service whose quality is to be increased based on the released band, the certain selection condition and the acquired service information; and requesting an increase of the quality level of the service.

The quality level increase step of the present invention includes the steps of: if release of the band is detected, notifying all of the information control devices connected to the transfer path about the release of the band; requesting reservation of a band necessary for increasing the quality level of a related service by the information control devices; and allocating a band to the request in order of request.

The certain selection condition of the present invention is based on at least one of the use status of the service, presence/absence of alternative services of different qualities, presence/absence of a quality change function at a provider of the service, a condition explicitly or implicitly specified by a user, and a random condition.

According to a data transfer control method of the present invention, in the case where a band necessary for a communication is deficient, a surplus band produced by decreasing the quality of a service provided by another information control device is released, whereby the necessary band can be quickly reserved without waiting for the end of a communication of other information control devices.

In the case where an available band is produced on a transfer path, the quality of a service which is in a quality-decreased state can be restored.

### BRIEF DESCRIPTION OF THE DRAWINGS

FIG. 1 is a block diagram showing a structure of a communication system which uses an information control device that employs a data transfer control method of the present invention.

FIG. 2 is a block diagram showing an example of a structure of an information control device that employs a data transfer control method of the present invention.

FIG. 3 shows an example of a connection management table stored in a connection management section which is part of an information control device that employs a data transfer control method of the present invention.

FIG. 4 shows an example of a service management table stored in a service management section which is part of an information control device that employs a data transfer control method of the present invention.

FIG. 5 shows an example of a connection management table stored in a connection management section which is part of an information control device that employs a data transfer control method of the present invention.

FIG. 6 shows an example of a service management table stored in a service management section which is part of an information control device that employs a data transfer control method of the present invention.

FIG. 7 shows an example of a connection management table stored in a connection management section which is part of an information control device that employs a data transfer control method of the present invention.

FIG. 8 shows an example of a service management table stored in a service management section which is part of an information control device that employs a data transfer control method of the present invention.

FIG. 9 is a flowchart illustrating an example of an operation at the start of a new service (at a device which reserves the band) in a data transfer control method of the present invention.

FIG. 10 shows an example of a connection management table stored in a connection management section which is part of an information control device that employs a data transfer control method of the present invention.

FIG. 11 shows an example of a service management table stored in a service management section which is part of an information control device that employs a data transfer control method of the present invention.

FIG. 12 is a flowchart illustrating an example of an operation at the start of a new service (at a device which does not reserve the band) in a data transfer control method of the present invention.

FIG. 13 shows an example of a service management table stored in a service management section which is part of an information control device that employs a data transfer control method of the present invention.

FIG. 14 is a flowchart illustrating an example of an operation performed when the band is deficient (at a device which detects a deficiency of the band) in a data transfer control method of the present invention.

FIG. 15 is a flowchart illustrating an example of an operation performed when the band is deficient (at a device which does not detect a deficiency of the band) in a data transfer control method of the present invention.

FIG. 16 shows an example of a connection management table stored in a connection management section which is part of an information control device that employs a data transfer control method of the present invention.

FIG. 17 shows an example of a service management table stored in a service management section which is part of an information control device that employs a data transfer control method of the present invention.

FIG. 18 is a flowchart illustrating an example of an operation performed when the band is released (at a device which detects release of the band) in a data transfer control method of the present invention.

FIG. 19 is a flowchart illustrating an example of an operation performed when the band is released (at a device which does not detect release of the band) in a data transfer control method of the present invention.

FIG. 20 shows an example of a connection management table stored in a connection management section which is part of an information control device that employs a data transfer control method of the present invention.

FIG. 21 shows an example of a service management table stored in a service management section which is part of an information control device that employs a data transfer control method of the present invention.

FIG. 22 shows an example of a connection management table stored in a connection management section which is part of an information control device that employs a data transfer control method of the present invention.

FIG. 23 shows an example of a service management table stored in a service management section which is part of an information control device that employs a data transfer control method of the present invention.

### BEST MODE FOR CARRYING OUT THE INVENTION

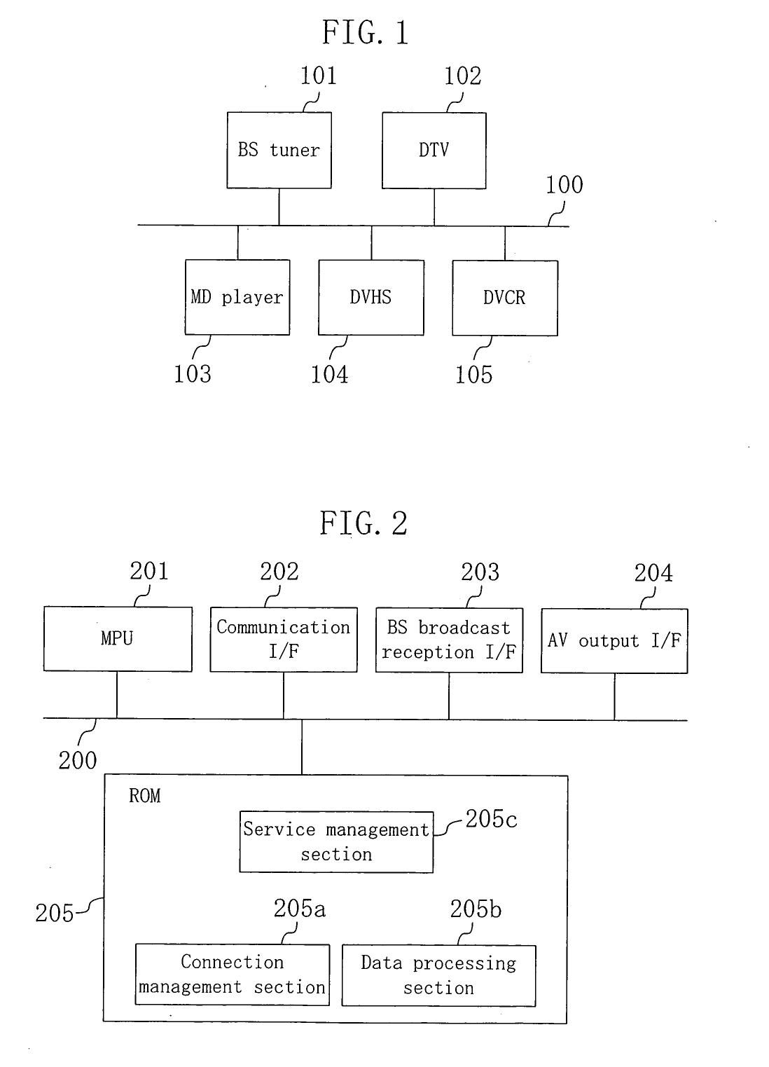

Hereinafter, an embodiment of the present invention is described in detail with reference to the drawings. FIG. 1 shows an example of a communication system including an information control device that employs a data transfer control method of the present invention. In FIG. 1, reference numeral 100 denotes a transfer path. A BS tuner 101, a DTV 102, an MD player 103, a DVHS 104 and a DVCR 105, each of which is an information control device of the present invention, are connected to the transfer path 100.

FIG. 2 is a block diagram showing an example of the BS tuner 101 which is an example of the information control device of the present invention. As shown in FIG. 2, the BS tuner 101 includes a central processing unit (MPU) 201 for controlling the entire operation through a system bus 200, a communication I/F 202 for establishing a connection to a transfer path which is based on IEEE 1394 communication standard, a BS broadcast reception I/F 203 for receiving a BS digital broadcast, an AV output I/F 204 for performing MPEG2-decoding of video/sound data received from the BS broadcast reception I/F 203, a ROM 205 for storing a program that controls the central processing unit 201, and the like. The ROM 205 stores programs, such as a connection management section 205a, a data processing section 205b, a service management section 205c, and the like.

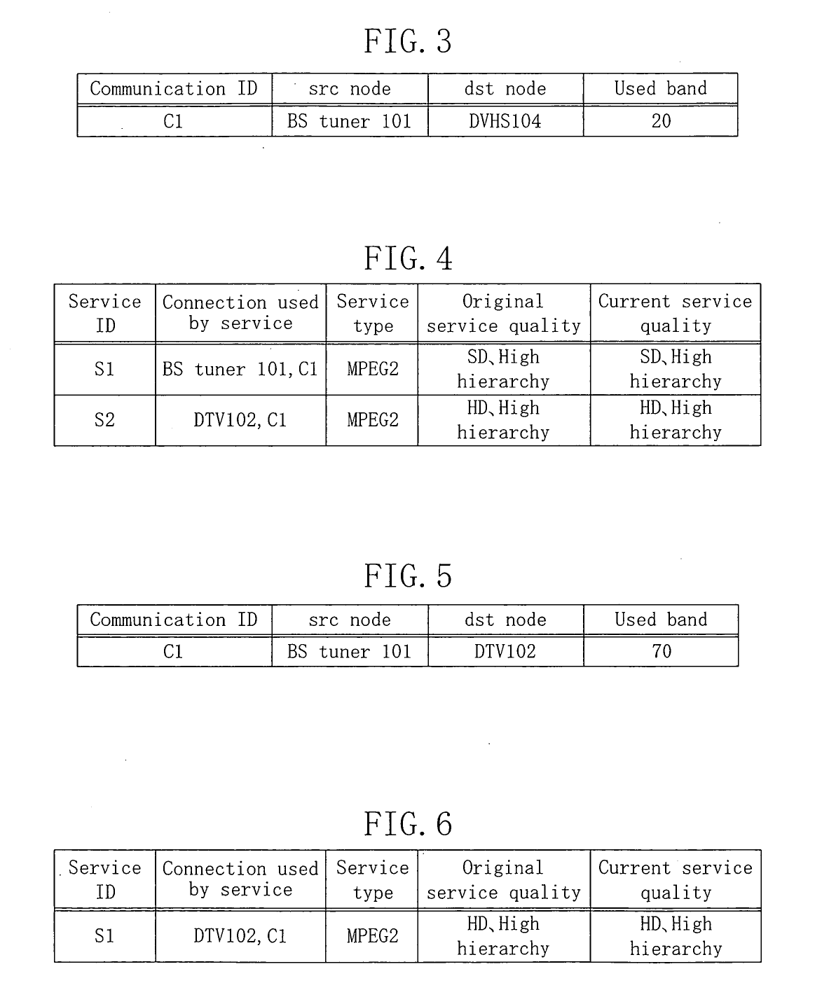

The connection management section 205a is a program which establishes a connection between information control devices of the present invention and manages the established connection based on an AV protocol communication standard. FIG. 3 shows an example of connection management in the connection management section 205a. As shown in FIG. 3, a connection between devices based on the AV protocol communication standard is managed mainly for a transmission side node (src node), a reception side node (dst node), and the band used in the communication. The connection management section 205a of each node manages only a connection directly established by its own node.

The data processing section 205b is a program which controls the AV output I/F 204 for transmitting sound/video data received by the BS broadcast reception I/F 203 to the transfer path through the communication I/F 202 or controls the AV output I/F 204 for MPEG2-decoding of sound/video data received from the communication I/F 202.

The service management section 205c manages correspondence between data processed by the data processing section 205b and connections used for transmitting/receiving the data. FIG. 4 shows an example of service management in the service management section 205c. As shown in FIG. 4, the service management section 205c stores the connections used for each service, the type of services, such as MPEG2-video, MP3-audio, DV, and the like, the service quality, such as HD (High Definition), SD (Standard Definition), high hierarchy, low hierarchy, the bit rate, and the like. The connection used for services is managed with a set of an information control device which establishes a connection and a connection ID stored in the connection management section 205a of the information control device in order to represent whether it is a connection established by its own node or a connection established by another node.

Although detailed descriptions of the structures of the DTV 102, the MD player 103, the DVHS 104 and the DVCR 105 are omitted, each of these includes a MPU 201, a communication I/F 202, a ROM 205, a connection management section 205a, a data processing section 205b, a service management section 205c, and the like, as does the BS tuner 101.

Hereinafter, an example of a data transfer control method of the present invention is described with reference to the drawings.

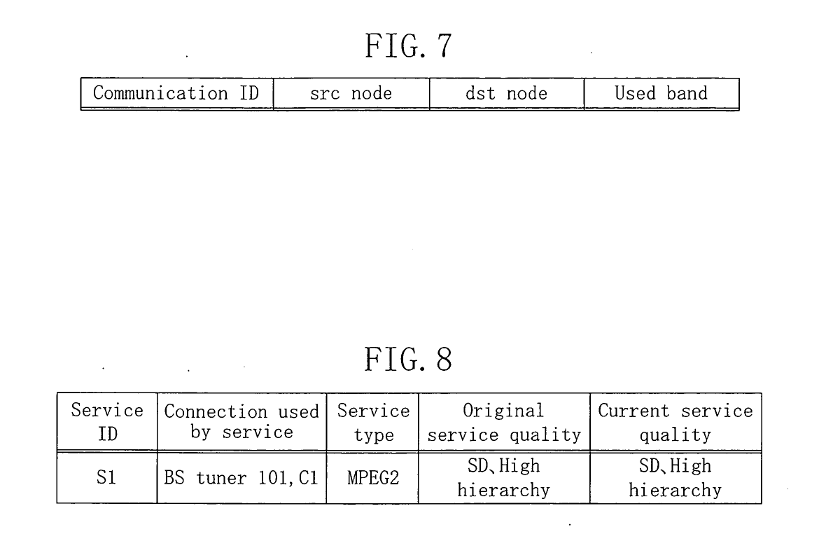

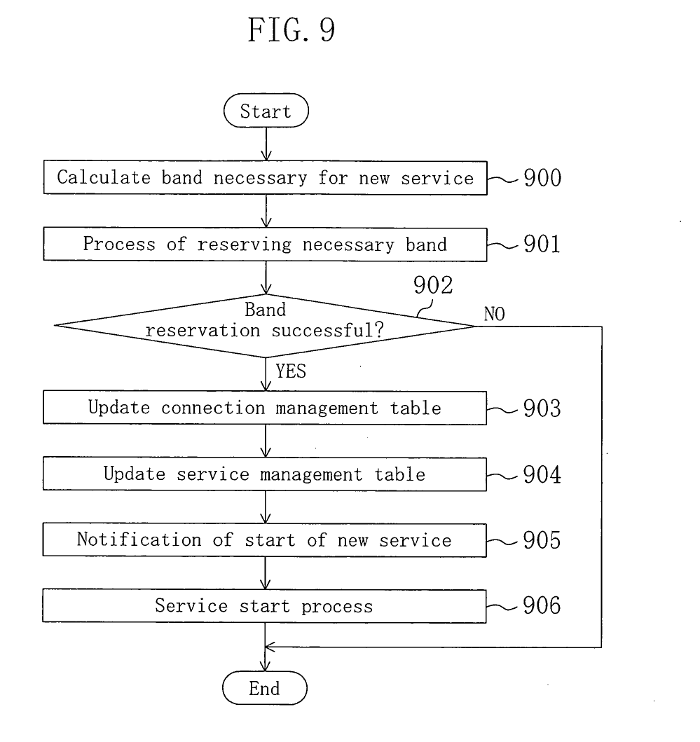

In the first place, the operation of an information control device of the present invention at the start of a service is described with reference to the flowcharts of FIGS. 9 and 12. Before the start of the process, the states of the management tables of the connection management section 205a and the service management section 205c in the BS tuner 101 are as shown in FIGS. 3 and 4. The states of the management tables of the connection management section 205a and the service management section 205c in the DTV 102 are as shown in FIGS. 5 and 6. The states of the management tables of the connection management section 205a and the service management section 205c in the DVHS 104 are as shown in FIGS. 7 and 8. It is assumed that none of a connection and a service is provided in the MD player 103 and the DVCR 105. Further, it is assumed that the band available over the entire transfer path is 100.

In an example described below, the BS tuner 101 establishes a connection for transmitting audio data of ATRAC3 format at 66 kbps from the MD player 103 to a node of its own (i.e., a node of the BS tuner 101). Herein, the band necessary for transmission of the audio data is 10.

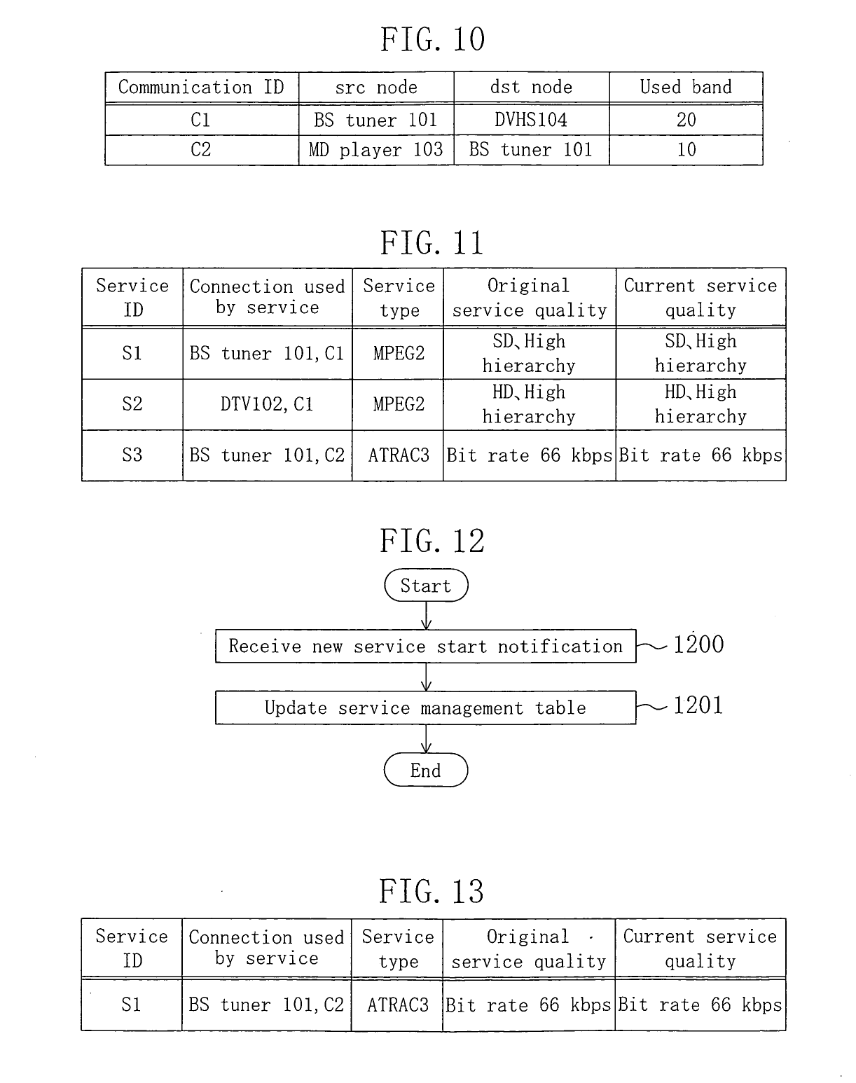

A new service at the BS tuner 101 is started by requesting the service management section 205c of the BS tuner 101 to start the service. The service management section 205c calculates the band necessary for transmission of the service from parameters, such as the type and quality of the service to be started (step 900 of FIG. 9), and requests the connection management section 205a to reserve the band of 10. The connection management section 205a performs the process of reserving a communication band based on the AV protocol communication standard (step 901). If the band reservation process is successful, the connection management section 205a updates the connection management table (steps 902 and 903) and notifies the service management section 205c about the success of band reservation. FIG. 10 shows the state of the updated connection management table managed by the connection management section 205a of the BS tuner 101. The service management section 205c registers a newly-started service in the service management table (step 904) and notifies the MD player 103 which is a communication partner about the start of the new service (step 905). FIG. 11 shows the state of the updated service management table managed by the service management section 205c of the BS tuner 101.

Receiving the notification about the start of the new service from the BS tuner 101 (step 1200 of FIG. 12), the MD player 103 adds information about the new service to the service management table (step 1201). FIG. 13 shows the state of the updated service management table managed by the service management section 205c of the MD player 103.

In the last, the BS tuner 101 performs the process of transmitting audio data in a data processing section 105b (step 906 of FIG. 9).

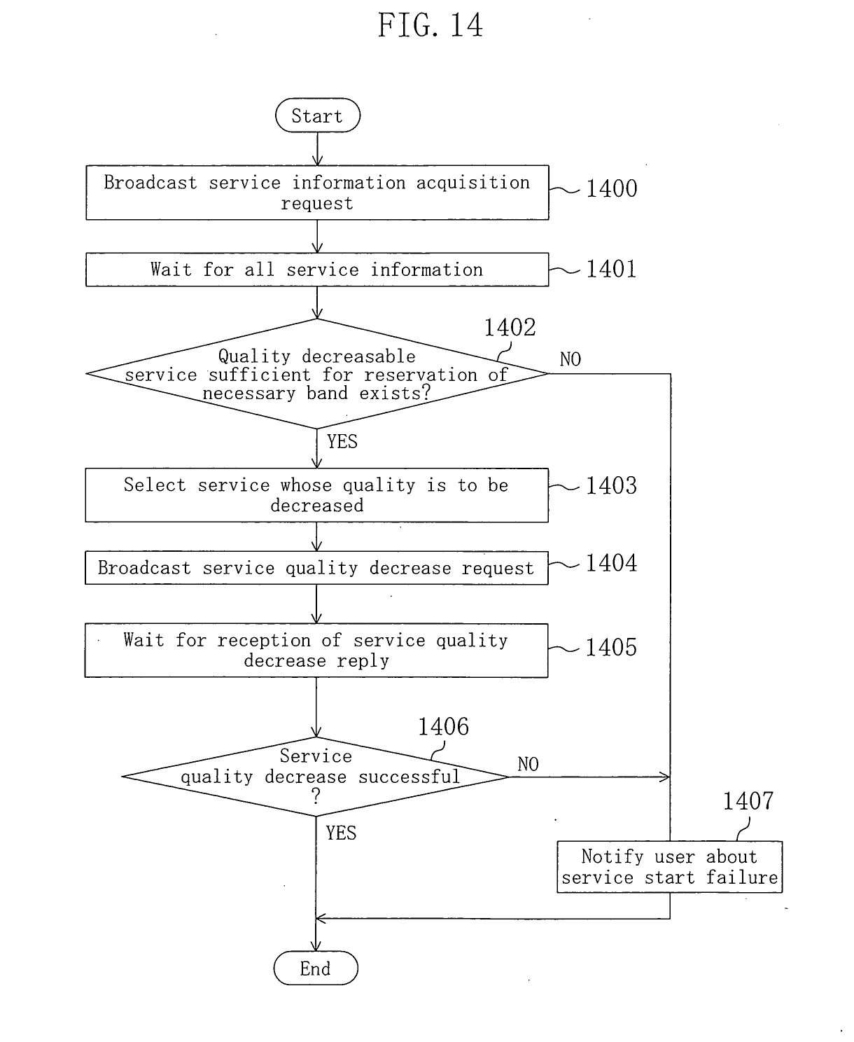

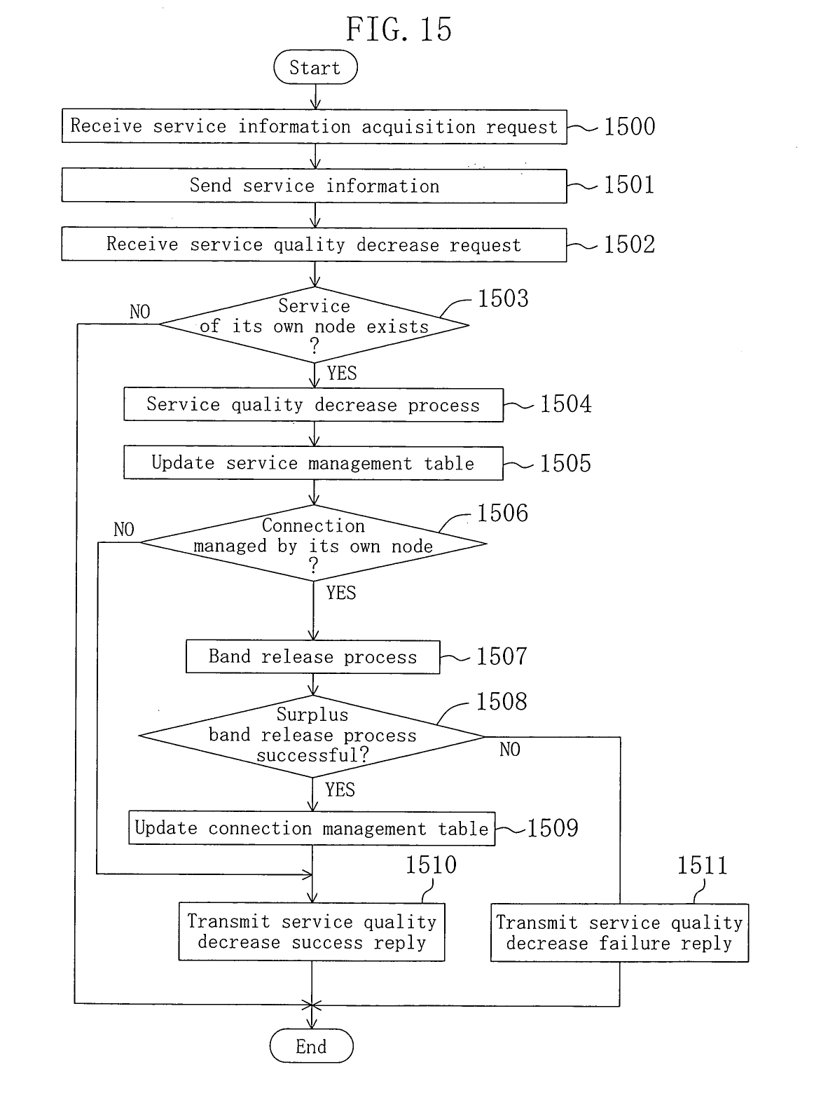

Next, the operation performed when the band necessary for transfer of the service cannot be reserved at the start of the service is described with reference to the flowcharts of FIGS. 14 and 15. Before the start of a process, the states of the management tables of the connection management section 205a and the service management section 205c in the BS tuner 101 are as shown in FIGS. 3 and 4. The states of the management tables of the connection management section 205a and the service management section 205c in the DTV 102 are as shown in FIGS. 5 and 6. The states of the management tables of the connection management section 205a and the service management section 205c in the DVHS 104 are as shown in FIGS. 7 and 8. It is assumed that none of a connection and a service is provided in the MD player 103 and the DVCR 105. Further, it is assumed that the band available over the entire transfer path is 100.

In an example described herein, the BS tuner 101 establishes a connection for transmitting audio data of ATRAC3 format at 132 kbps from the MD player 103 to a node of its own (i.e., a node of the BS tuner 101). Herein, the band necessary for transmission of the audio data is 20.

The connection management section 205a of the BS tuner 101 detects the failure of establishment of the connection for starting a new service. Receiving a notification from the connection management section 205a, the service management section 205c broadcasts a service information acquisition request to all of the information control devices on the transfer path (step 1400 of FIG. 14) and waits for service information from all of the information control devices or an appropriate timeout (step 1401).

The DTV 102 on the transfer path receives the service information acquisition request from the BS tuner 101 (step 1500 of FIG. 15) and sends by return the service information managed by the service management section 205c to the BS tuner 101 (step 1501). The other information control devices on the transfer path, the MD player 103, the DVHS 104 and the DVCR 105, also send by return the service information to the BS tuner 101 in the same manner. The service information sent by return includes information of a service management table and a connection management table which are managed in each information control device.

Receiving the service information from all of the information control devices on the transfer path, the BS tuner 101 selects from among all of the received information a list of services whose quality can be decreased to reduce the band in accordance with the deficient band (steps 1402 and 1403 of FIG. 14). If there is no combination of services whose quality can be decreased to secure a sufficient band that covers the deficient band, a user is notified about failure of start of the service, and the process is ended (step 1407).

The criterion for selecting a service whose quality is to be decreased is based on various conditions, for example, the use status of the service such that a service which is being recorded through the transfer path is not selected, the property of service data such that a service in which a plurality of qualities of data are available beforehand, such as BS digital broadcast with high-hierarchy and low-hierarchy, is selected by priority, the conditions of a service provider, e.g., whether or not an information control device on the service provider's side includes hardware for down-converting HD video data to SD video data in BS digital broadcast, the user's preference, e.g., whether the service quality is decreased in one service with a large decrement or in a plurality of services with a small decrement for each service, or selection on a random basis. In the example of the present embodiment, the quality of an MPEG2 video service which is being transmitted from the BS tuner 101 to the DTV 102 is decreased from HD quality to SD quality, whereby the band used for this service is reduced.

A surplus band produced by converting the MPEG2-encoded HD video data to SD video data is simply (band used by HD video data)−(band used by SD video data), i.e., the difference between the band used by HD video data and the band used by SD video data. The bands used by HD video data and SD video data are defined in the AV protocol communication standard and can be calculated from the data format and quality parameters of the service which is managed by the service management section 205c.

After a list of services whose quality is to be decreased is determined, the BS tuner 101 broadcasts a service quality decrease request including the list (step 1404 in FIG. 14) and waits for a service quality decrease reply (step 1405).

Receiving the service quality decrease request from the BS tuner 101 (step 1502 in FIG. 15), the DTV 102 determines whether or not a service related to a node of its own (i.e., a node of the DTV 102) is included in the service list that is contained in the request (step 1503). If it is included, the DTV 102 performs the process of decreasing the service quality of all of the listed services in a data processing section 205b (step 1504). In the example of the present embodiment, service S1 in the service management table in the DTV 102 corresponds to the service whose quality is to be decreased, and thus, the settings of an MPEG2-decoder used for reproduction of service S1 are changed to the SD mode. Thereafter, the management table is updated in the service management section 205c (step 1505). FIG. 17 shows the state of the updated service management table in the service management section 205c of the DTV 102.

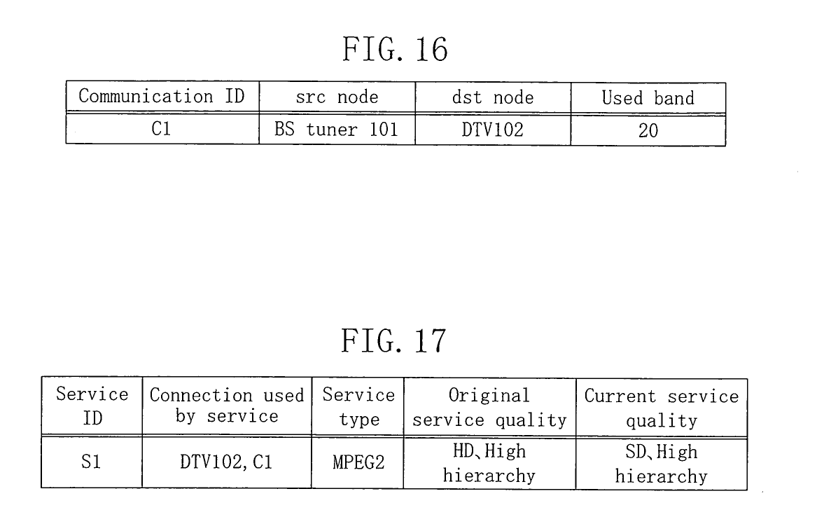

If a connection used by the service whose quality has been decreased is a connection managed by a node of its own (i.e., the node of the DTV 102), the DTV 102 reduces the band of the connection based on the AV protocol communication standard (steps 1506 and 1507). In the example of the present embodiment, the DTV 102 attempts to reduce the band of connection Cl from 70 to 20. If successful, the connection management table is updated according to the change of the band (steps 1508 and 1509). FIG. 16 shows the state of the updated connection management table in the connection management section 205a of the DTV 102.

In the last, a result of the service quality change process is transmitted to the BS tuner 101 (steps 1510 and 1511). In the example of the present embodiment, the node of the provider of the service whose quality is changed happens to be identical to the node that detects the band deficiency, and accordingly, a communication is not necessary for requesting a change of the service quality. However, in general, it is necessary to issue the request by communication to the information control devices of both the service provider and the service receiver.

The BS tuner 101 receives a result of the change of the service quality from the DTV 102. If it is a failure, the user is notified about the failure of the service start process (step 1407 in FIG. 14), and the process is terminated. If it is a success, reservation of the necessary band is attempted according to the flowchart of FIG. 9.

In the example of the present embodiment, a service information acquisition request is unconditionally broadcast when the service whose quality is to be decreased is selected. However, in the case where a node which attempts to start a service is identical to a node which provides the service whose quality is to be decreased as in the above-described example, the service information acquisition process may be omitted by priorly decreasing the quality of the service in which a node of its own is involved.

In the example of the present embodiment, the BS tuner 101, which is an information control device that has detected a band deficiency, requests service information from other information control devices and selects from the service information the services whose quality can be decreased by the BS tuner 101, whereby a list of the services whose quality can be decreased is determined. However, an alternative implementation is possible wherein when a band deficiency is detected, for example, a service quality decrease request including deficient band information, or the like, is broadcast, and the available band is increased by decreasing the quality of all the services whose quality can be decreased in all of the information control devices, whereby the necessary band is reserved.

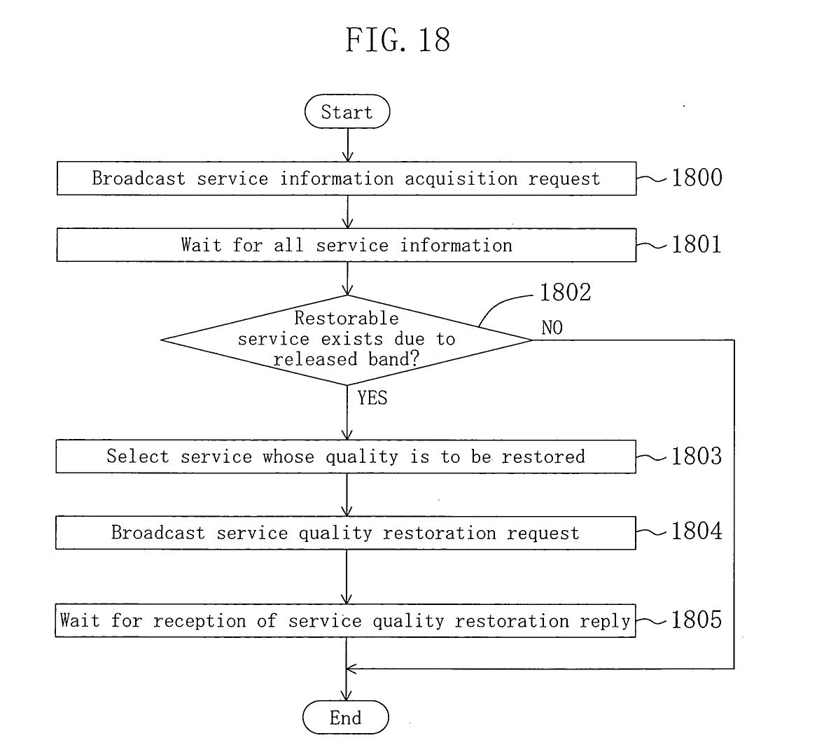

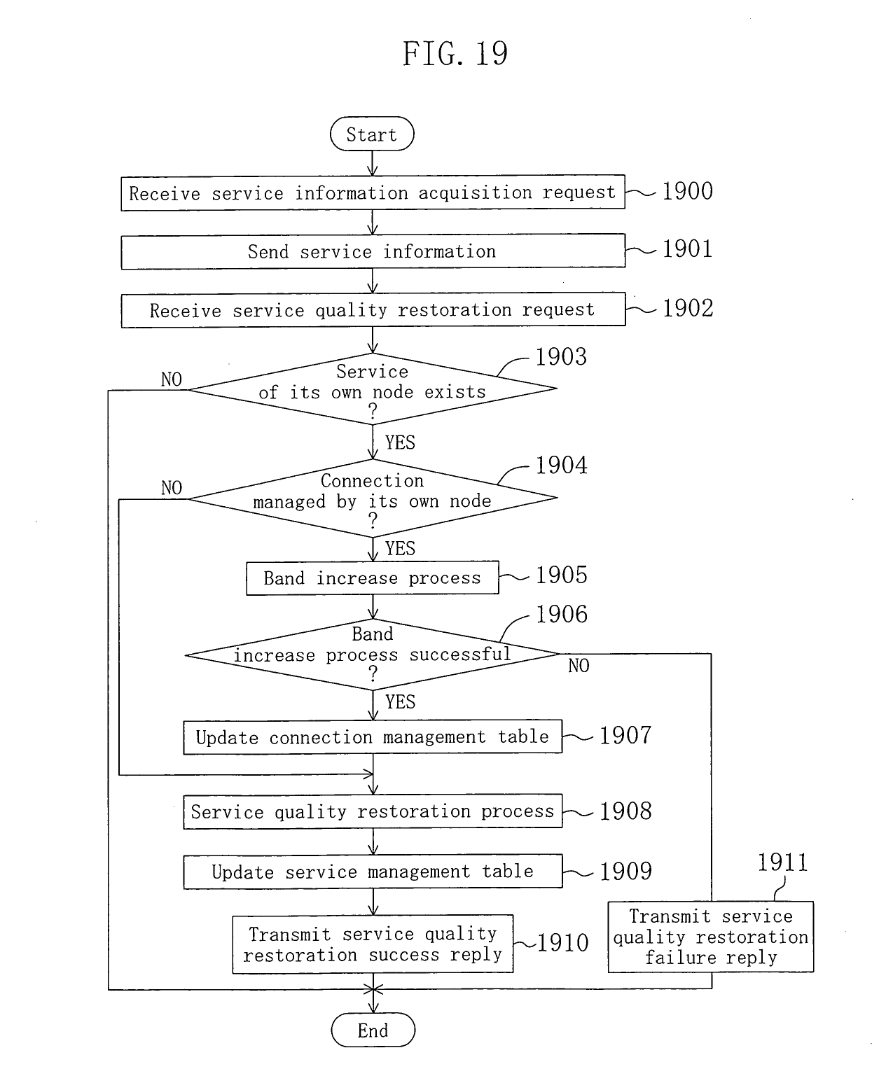

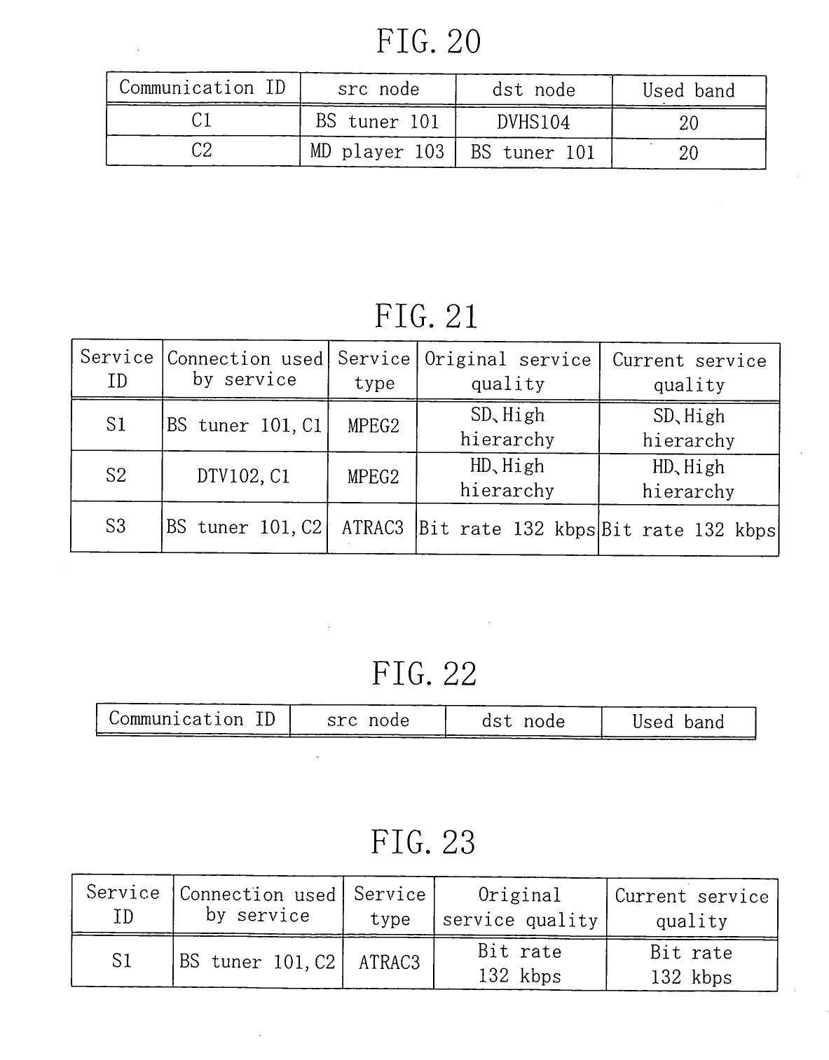

Then, the operation performed when a service in a state of decreased quality is restored at the end of an existing service is described with reference to the flowcharts of FIGS. 18 and 19. Before the start of a process, the states of the management tables of the connection management section 205a and the service management section 205c in the BS tuner 101 are as shown in FIGS. 20 and 21. The states of the management tables of the connection management section 205a and the service management section 205c in the DTV 102 are as shown in FIGS. 16 and 17. The states of the management tables of the connection management section 205a and the service management section 205c in the MD player 103 are as shown in FIGS. 22 and 23. The states of the management tables of the connection management section 205a and the service management section 205c in the DVHS 104 are as shown in FIGS. 7 and 8. It is assumed that none of a connection and a service is provided in the DVCR 105. Further, it is assumed that the band available over the entire transfer path is 100.

The following description is provided with an example where the BS tuner 101 ends an only service provided between the BS tuner 101 and the MD player 103. There is a service of decreased quality between the BS tuner 101 and the DTV 102 (service S2 in the BS tuner 101).

Receiving a band release notification from the connection management section 205a, the service management section 205c in the BS tuner 101 broadcasts a service information acquisition request to all of the information control devices on the transfer path (step 1800) and waits for service information from all of the information control devices or an appropriate timeout (step 1801).

The DTV 102 on the transfer path receives the service information acquisition request from the BS tuner 101 (step 1900) and sends by return the service information managed by the service management section 205c to the BS tuner 101 (step 1901). The other information control devices on the transfer path, the MD player 103, the DVHS 104 and the DVCR 105, also send by return the service information to the BS tuner 101 in the same manner. The service information sent by return includes information of a service management table and a connection management table which are managed in each information control device.

Receiving the service information from all of the information control devices on the transfer path, the BS tuner 101 selects from among all of the received information a list of services whose quality can be restored using the released band (steps 1802 and 1803). If there is no service whose quality can be restored, the process is ended. In the example of the present embodiment, a service between the BS tuner 101 and the DTV 102 (service S2 at the BS tuner 101) is selected.

After the list of services whose quality can be restored is determined, the BS tuner 101 broadcasts a service quality restoration request including the list (step 1804) and waits for a service quality restoration reply (step 1805).

Receiving the service quality restoration request from the BS tuner 101 (step 1902), the DTV 102 determines whether or not a service which is related to a node of its own (i.e., a node of the DTV 102) is included in the service list included in the request (step 1903). If such a service is not included in the list, the process is ended. If such a service is included in the list, the DTV 102 determines whether or not the service uses a connection managed by a node of its own (i.e., a node of the DTV 102) (step 1904). If the service uses such a connection, the DTV 102 newly reserves a band necessary for restoration of the service quality based on the AV protocol communication standard (step 1905). If the band reservation is failed (step 1906), the DTV 102 sends by return a service quality restoration failure reply to the BS tuner 101 (step 1911) and ends the process. If successful, the connection management table is updated according to details of the change (step 1907).

Thereafter, a service quality restoration process is performed in the data processing section 205b of the DTV 102 (step 1908). In the example of the present embodiment, the settings of an MPEG2 decoder are changed such that the quality of service S1 in the DTV 102 is restored from SD to HD, and the management table is updated in the service management section 205c (step 1909).

In the last, the DTV 102 sends by return a service quality restoration success reply to the BS tuner 101 (step 1910). In the example of the present embodiment, a node of a provider of a service whose quality is restored happens to be identical to a node which detects release of the band, and accordingly, a communication is not necessary for requesting restoration of the service quality. However, in general, it is necessary to issue the request by communication to the information control devices of both the service provider and the service receiver.

In the example of the present embodiment, a service information acquisition request is unconditionally broadcast when the service whose quality is to be restored is selected. However, in the case where a node which releases the band is identical to a node which provides the service whose quality is to be decreased as in the above-described example, the service information acquisition process may be omitted by priorly restoring the quality of the service in which a node of its own is involved.

In the example of the present embodiment, the BS tuner 101, which is an information control device that has detected a band deficiency, requests service information from other information control devices and selects from the service information the services whose quality can be restored by the BS tuner 101, whereby a list of the services whose quality can be restored is determined. However, an alternative implementation is possible wherein, for example, a node which has detected a band deficiency broadcasts a service quality restoration request including released-band information, or the like, and all of the information control devices including a service of decreased quality, which have received the request, attempt to reserve the band for restoration of the service in order of request.

It is apparent that, although the present invention has been described with reference to the specific examples described above, the present invention is not limited to the above examples and can be modified without departing from the extent of the present invention. The extent of the present invention cannot be determined without considering the claims appended to this specification.

What is claimed is:

1. A data transfer control method employed in an information control device including a communication interface which provides band reservation means, the method comprising:
a band reservation request step of requesting reservation of a communication band;
if the band reservation is failed due to band deficiency, a band reduction step of reducing the band reserved by the information control device connected to a transfer path; and
a released-band reservation step of reserving the band released at the band reduction step.

2. A data transfer control method employed in an information control device including a communication interface which provides band reservation means, the method comprising a band increase step of increasing the band reserved by the information control device based on a band released by the information control device connected to a transfer path.

3. The data transfer control method of claim 1, wherein the communication interface conforms to IEEE 1394 communication standard.

4. The data transfer control method of claim 2, wherein the communication interface conforms to IEEE 1394 communication standard.

5. The data transfer control method of claim 1, further comprising:
a band reservation failure detection step of detecting a failure of band reservation due to band deficiency; and
a quality level decrease step of decreasing the quality level of at least one of services related to the information control device connected to the transfer path based on the deficient band and a certain selection condition.

6. The data transfer control method of claim 2, further comprising:
a band release detection step of detecting release of a band by any information control device connected to the transfer path; and
a quality level increase step of increasing the quality level of at least one of services related to the information control device based on the released band and a certain selection condition.

7. The data transfer control method of claim 5, wherein the quality level decrease step includes the steps of:
if the band reservation is failed, requesting all of the information control devices connected to the transfer path to acquire information of a related service;
selecting a service whose quality is to be decreased based on the deficient band, the certain selection condition and the acquired service information; and
requesting a decrease of the quality level of the service.

8. The data transfer control method of claim 5, wherein the quality level decrease step includes the steps of:
if the band reservation is failed, requesting all of the information control devices connected to the transfer path to decrease the quality level of a related service; and
decreasing the quality level of the service based on the deficient band, the certain selection condition and information of the service related to the information control device.

9. The data transfer control method of claim 6, wherein the quality level increase step includes the steps of:
if release of the band is detected, requesting all of the information control devices connected to the transfer path to acquire information of a related service;
selecting a service whose quality is to be increased based on the released band, the certain selection condition and the acquired service information; and
requesting an increase of the quality level of the service.

10. The data transfer control method of claim 6, wherein the quality level increase step includes the steps of:
if release of the band is detected, notifying all of the information control devices connected to the transfer path about the release of the band;
requesting reservation of a band necessary for increasing the quality level of a related service by the information control devices; and
allocating a band to the request in order of request.

11. The data transfer control method of claim 5, wherein the certain selection condition is based on at least one of the use status of the service, presence/absence of alternative services of different qualities, presence/absence of a quality change function at a provider of the service, a condition explicitly or implicitly specified by a user, and a random condition.

12. The data transfer control method of claim 6, wherein the certain selection condition is based on at least one of the use status of the service, presence/absence of alternative services of different qualities, presence/absence of a quality change function at a provider of the service, a condition explicitly or implicitly specified by a user, and a random condition.
